(19) United States
(12) Patent Application Publication
(10) Pub. No.: US 2012/0288102 A1
(43) Pub. Date: Nov. 15, 2012

(54) Highly Directional Glassbreak Detector

(75) Inventor: Richard Alan Smith, El Dorado Hills, CA (US)

(73) Assignee: Honeywell International Inc., Morristown, NJ (US)

(21) Appl. No.: 13/105,026

(22) Filed: May 11, 2011

(51) Int. Cl. H04R 29/00

(52) U.S. Cl. 381/56

(57) ABSTRACT

A glassbreak detector first and second different audio transducers. One transducer is omnidirectional. The other is highly directional. Control circuitry processes signals from both transducers and determines if a glassbreakage profile is present.

### FIELD

The application pertains to glassbreak detectors. More particularly, the application pertains to such detectors which include highly directional audio transducers.

### BACKGROUND

Glassbreak detectors are commonly used, to provide environmental feedback as to the condition of windows, in security systems which are intended to monitor a predetermined region. Despite their usefulness, they at times have problems with false alarms which occur from displaced locations which are in a different direction than the window being protected. This is because they commonly use a microphone which is omni-directional by design, resulting in the detector being sensitive to sounds occurring from any direction. Although uni-directional microphones are available, they are designed in manner that makes it difficult to distinguish the direction from which an unidentified sound is originating.

In a known prior art implementation of a glassbreak detector, a time of arrival method is implemented using two omni-directional microphones. The microphones are arranged opposed to one another on the order of 180 degrees. This configuration forms a protected zone and an excluded zone. Signals from the two microphones can be processed to detect sounds of glass breaking from the protected zone.

### BRIEF DESCRIPTION OF THE DRAWINGS

FIG. 1 is a block diagram of a detector which includes a highly directional audio transducer; and

FIG. 2 is a flow diagram illustrating one form of operation of a detector as in FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In accordance herewith, a glassbreak detector that is highly sensitive to the direction the sound is coming from incorporates both an omnidirectional audio transducer, such as an omnidirectional microphone, and a highly directional audio transducer. Additionally, the device can be installed so that it is “aimed” towards the window(s) being protected. As a result, false alarms can be reduced. Another embodiment can be used to identify the location and/or movements of room occupants for high security applications.

In one embodiment, highly directional mems-type acoustical sensors, known as microflowns, could be used in conjunction with an omni-directional microphone. This combination results in a glassbreak detector with reduced susceptibility to false alarms, and, achieves a high degree of detection when the protected windows are subjected to forced entry. This detector could be installed in a room “aimed” at the window(s) it is intended to protect, and would be programmed to identify the origin direction of sound events to be processed. It could also determine if acoustical characteristics of an event were indicative of a forced entry through the protected window(s), or a false alarm. An alarm event can be communicated to an alarm panel using known methods.

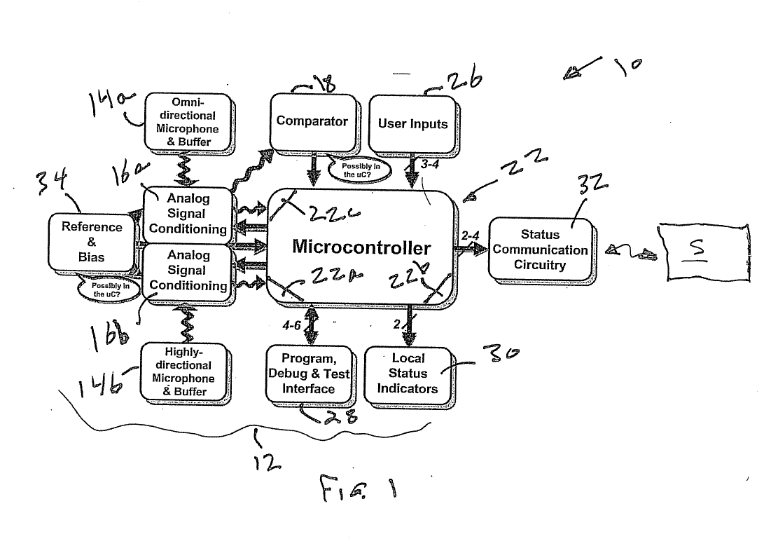

FIG. 1 is a block diagram of an embodiment of an environmental condition detector 10, for example a highly directional glassbreak detector, in accordance herewith. Detector 10 has a housing 12 which carries a plurality of electronic components.

Detector 10 includes at least two audio sensors 14a 14b. One sensor 14a can be implemented, for example as an omnidirectional microphone and buffer circuits. The second 14b can be implemented as a highly directional audio transducer such as a microflown-type mems sensor. Buffered outputs from the sensors 14a, 14b can be coupled to analog signal conditioning circuitry 16a, 16b.

Conditioned analog, or digital, outputs from one or both circuits 16a, 16b can be coupled to comparator circuits 18, and/or to control circuits 22. Control circuits 22 can include the comparator circuits 18. Control circuits 22 could be implemented, at least in part, with a programmable processor 22a and pre-stored control programs 22b stored on non-volatile storage circuits 22c.

Control circuits 22 are also coupled to user input circuits 26 which enable a user to specify installation parameters or conditions. A program, debug and test interface 28, coupled to control circuits 22, facilitates initial programming, debugging and testing of the detector 10. The interface 28 can be used after installation to evaluate parameters or other data stored in the non-volatile circuits 22c. For example, results of tests or installation of the detector 10 can be stored in circuits 22c for subsequent retrieval and evaluation.

Local status indicators 30, for example, audible or visual indicators such as audio output devices, LEDs, liquid crystal displays or the like, are coupled to circuits 22 and activated thereby to provide local status information. Status communication circuitry 32, coupled to control circuits 22, provides wired or wireless communication with a displaced regional monitoring system S as would be understood by those of skill in the art.

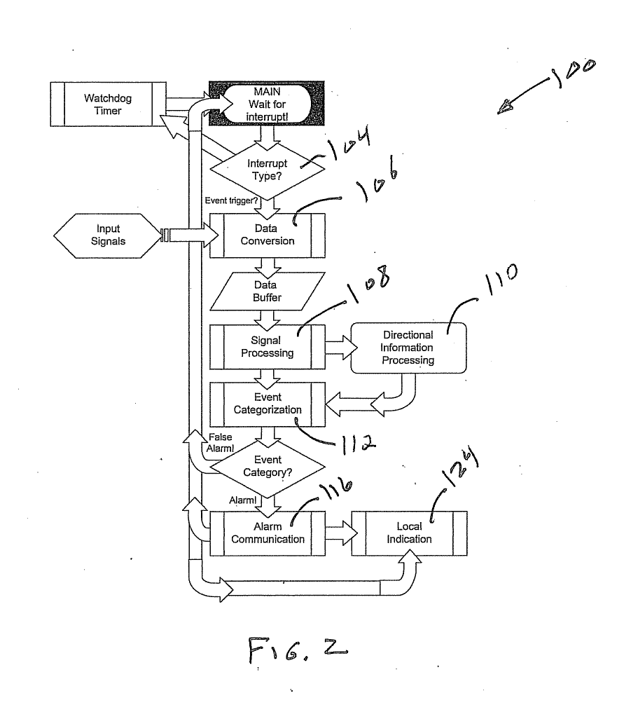

FIG. 2 illustrates exemplary aspects of processing 100 at the detector 10. In response to detecting an event-indicating interrupt, as at 104, the control circuits 22 can acquire and convert, as at 106, one or more input signal values, from sensors 14a, 14b. Those signals can be processed, as at 108, including evaluating directional information relative to transducer 14b as at 110, and categorized as to type of event, as at 112.

An alarm event can generate an alarm communication, as at 116, either locally, via output devices 30, or via communications interface 32. False alarms can advantageously be detected and rejected.

A detected set-up event can be evaluated to determine if installation had been carried out as expected. Installation setup data can be stored in, loaded into, memory 22c. A local indication thereof can be provided, as at 124 via output device(s) 30.

Events can be logged, not shown, and stored in non-volatile memory 22c for after-installation review. Data, for example, one or more operational parameters, installation and setup data, along with information relative to logged events can be retrieved from the memory 22c and output via the local interface 28, local indicators 30, or communications interface 32.

The pre-stored operational parameters, setup, or installation, data make possible after-installation reviews to evaluate the operation of the detector 10. Where a detector, such as 10, has failed to perform as expected, such pre-stored information may be the only indicia as to the field condition of the unit. Advantageously, all such data, without limitation, can be detected and stored in real-time and subsequently retrieved.

It will be understood that other types of sensors including position, thermal, smoke, infra-red, smoke gas or flame sensors can be incorporated into detector 10 and all come within the spirit and scope hereof. The specific details of microphones, audio transducers or other types of sensors are not limitations hereof.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A detector comprising:
a housing;
first and second acoustic transducers, carried by the housing, one transducer is omnidirectional, the other is highly directional, and
control circuits carried by the housing, coupled to the transducers with the control circuits including processing circuitry to evaluate signals from the transducers to detect if an indicator of a glassbreak has been received.

2. A detector as in claim 1 which includes at least one of analog or digital conditioning circuits to process signals from the transducers.

3. A detector as in claim 2 where the control circuits receive processed signals from the conditioning circuits and evaluate those signals for the presence of false alarms.

4. A detector as in claim 3 where the control circuitry includes circuitry to evaluate the processed signals for the presence of at least one glass breakage profile.

5. A detector as in claim 3 where the control circuitry includes circuitry to evaluate a direction of origin of the at least one of the conditioned signals.

6. A detector as in claim 5 where the other transducer is receptive of sounds from the direction of origin and is less receptive of sounds from different directions, and wherein the control circuitry includes circuitry to evaluate differences in conditioned signals from the first and second transducers.

7. A detector as in claim 6 which includes circuitry to evaluate the conditioned signals for the presence of a glass breakage profile.

8. A detector as in claim 6 which includes circuitry to evaluate the conditioned signals for the presence of false alarms.

9. A detector as in claim 3 where the one transducer comprises an omnidirectional microphone and the other comprises a transducer with an arcuate sound response which extends over an angle substantially less than one hundred twenty degrees.

10. A detector as in claim 3 which includes storage circuits for installation and setup data, logged events, or operational parameters.

11. A detector as in claim 10 which includes interface circuitry, coupled to the control circuits and the storage circuits wherein information in the storage circuits can be retrieved.

12. A glassbreak detector comprising:
an omnidirectional audio sensor;
a directional audio sensor; and
control circuits coupled to the sensors, wherein the control circuits implement directional information processing, responsive to signals received from the sensors, and determine if the received signals are indicative of glass breaking.

13. A detector as in claim 12 where the control circuits determine if the received signals are indicative of a false alarm.

14. A detector as in claim 12 which includes storage circuitry, coupled to the control circuits wherein at least one of operational parameters, installation data, or information relative to logged events can be stored substantially in real-time and subsequently retrieved.

15. A detector as in claim 12 wherein the omnidirectional audio sensor comprises an omnidirectional microphone, and the directional audio sensor comprises a mems-type directional sensor.

16. A method comprising:
sensing audio omnidirectionally;
sensing audio from a target direction;
combining the audio to establish a composite profile; and
evaluating the profile to establish the presence of a predetermined condition.

17. A method as in claim 16 which includes determining if the profile is indicative of breaking glass.

18. A method as in claim 16 which includes determining if the profile is indicative of a false alarm.
